(19) United States
(12) Patent Application Publication
(10) Pub. No.: US 2024/0345864 A1
(43) Pub. Date: Oct. 17, 2024

(54) TECHNIQUES FOR MIGRATING CLUSTER DATA

(71) Applicant: VIANAI SYSTEMS, INC., Palo Alto, CA (US)

(72) Inventor: Thomas J. MARTIN, JR., Oviedo, FL (US)

(21) Appl. No.: 18/634,580

(22) Filed: Apr. 12, 2024

Related U.S. Application Data
(60) Provisional application No. 63/496,350, filed on Apr. 14, 2023.

(51) Int. Cl. G06F 9/455

(52) U.S. Cl. CPC G06F 9/45558; G06F 2009/4557; G06F 2009/45583

(57) ABSTRACT

One embodiment of a method for migrating data includes performing one or more first operations to orchestrate execution of one or more first scripts in one or more first virtual computing instances, wherein the execution of the one or more first scripts causes data associated with the one or more first virtual computing instances to be backed up to at least one first disk, copying the data from the at least one first disk to at least one second disk, and performing one or more second operations to orchestrate execution of one or more second scripts in one or more second virtual computing instances, wherein the execution of the one or more second scripts causes the data to be restored from the at least one second disk to the one or more second virtual computing instances.

### CROSS-REFERENCE TO RELATED APPLICATIONS

This application claims priority benefit of the United States Provisional Patent Application titled, “TECHNIQUES FOR MIGRATING CLUSTER DATA,” filed on Apr. 14, 2023, and having Ser. No. 63/496,350. The subject matter of this related application is hereby incorporated herein by reference.

### BACKGROUND

### Field of the Various Embodiments

Embodiments of the present disclosure relate generally to computer science and cloud computing and, more specifically, to techniques for migrating cluster data.

### Description of the Related Art

Software applications are increasingly being executed on cloud computing systems, as opposed to local machines. For example, an application can be deployed to execute in one or more containers that run on a cluster of nodes within a cloud computing system. In such cases, each node can be a physical machine or a virtual machine.

Oftentimes, applications executing on cloud computing systems need to be backed up for disaster recovery purposes. One conventional approach for backing up an application executing on a cloud computing system is to take snapshots of the virtual disks associated with the cluster of nodes on which the application executes. Thereafter, the snapshots can be used to recover the application on a new cluster of nodes.

One drawback of the above approach for backing up an application executing on a cloud computing system is that the snapshots can only be used to recover the application on a new cluster of nodes that has the same configuration as the previous cluster of nodes for which the snapshots were taken. The same configuration is required because the snapshots are copies of virtual disks, and such copies typically can only work properly using nodes having the same configurations. Some examples of configuration aspects that need to be the same include the new cluster having the same number of nodes as the previous cluster, the new cluster having the same pools of nodes as the previous cluster, and the new cluster having the same affinities of how containers are scheduled on nodes as the previous cluster.

As the foregoing illustrates, what is needed in the art are more effective techniques for backing up and restoring applications executing on cloud computing systems.

### SUMMARY

One embodiment of the present disclosure sets forth a computer-implemented method for migrating data. The method includes performing one or more first operations to orchestrate execution of one or more first scripts in one or more first virtual computing instances, wherein the execution of the one or more first scripts causes data associated with the one or more first virtual computing instances to be backed up to at least one first disk. The method further includes copying the data from the at least one first disk to at least one second disk. In addition, the method includes performing one or more second operations to orchestrate execution of one or more second scripts in one or more second virtual computing instances, wherein the execution of the one or more second scripts causes the data to be restored from the at least one second disk to the one or more second virtual computing instances.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that an application can be restored on a cluster of nodes having a different configuration than a previous cluster of nodes on which the application was executed. Restoring the application on a cluster of nodes having a different configuration permits the application to be migrated across different computing systems, such as from one cloud computing system to another cloud computer system, from an on-premise data center to a cloud computing system or vice versa, etc. Restoring the application on a cluster of nodes having a different configuration also permits application data to be restored on a different version of an application or a cloned version of an application.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments;

FIG. 2 illustrates in greater detail a node of the system of FIG. 1, according to various embodiments;

FIG. 3 illustrates a method for backing up cluster data, according to various embodiments; and

FIG. 4 illustrates a method for restoring backed up data on a cluster, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

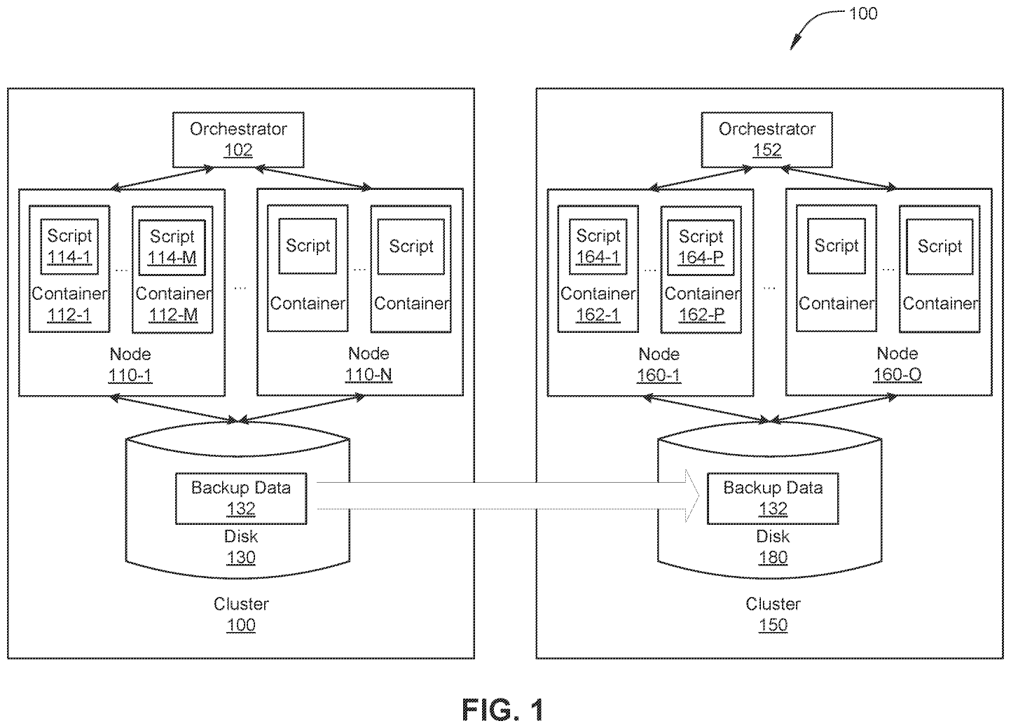

FIG. 1 illustrates a system 100 configured to implement one or more aspects of various embodiments. As shown, the system includes a cluster 100 and a cluster 150. In some embodiments, a distributed application can execute across each of the clusters 100 and 150. The clusters 100 and 150 can be implemented in any technically feasible manner in some embodiments. For example, in some embodiments, the clusters 100 and 150 can be implemented on different cloud computing systems, such as cloud computing systems provided by different commercially available cloud providers. As another example, in some embodiments, one of the clusters 100 and 150 can be implemented in a cloud computing system, and the other of the clusters 100 and 150 can be implemented in an on premise data center. As another example, in some embodiments, the cluster 110 can provide one version (e.g., a free trial version) of a distributed application, and the cluster 150 can provide another version (e.g., a full version) of the distributed application. As yet another example, in some embodiments, the cluster 110 can be cloned to the cluster 150.

Illustratively, the cluster 110 includes a number of nodes 110-1 to 110-N (referred to herein collectively as nodes 110 and individually as a node 110), an orchestrator 102, and a disk 130. Similarly, the cluster 150 includes a number of nodes 160-1 to 160-O (referred to herein collectively as nodes 160 and individually as a node 160), an orchestrator 152, and a disk 180. In some embodiments, each of the nodes 110 and 160 is a physical machine or a virtual machine (VM) in which containers can run. In some embodiments, each of the orchestrators 102 and 152 is a workflow or any other technically feasible application that runs in the cluster 110 and the cluster 150, respectively. In some embodiments, each of the disks 130 and 130 can be a shared mount point, a shared bucket, or any other technically feasible storage.

As shown, containers 112-1 to 112-M (referred to herein collectively as containers 112 and individually as a container 112) run in the node 110-1, and containers 162-1 to 162-P (referred to herein collectively as containers 162 and individually as a container 162) run in the node 160-1. Similar containers run in the other nodes 110 and 160. In some embodiments, the containers running in a node can be grouped into one or more pods, with each pod including shared storage and network resources as well as a specification for how to run the containers therein. Although described herein with respect to containers as a reference example, in some embodiments, the containers can be replaced with any technically feasible virtual computing instances, such as VMs.

Each of the containers 112-1 to 112-M includes a backup script 114-1 to 114-M (referred to herein collectively as backup scripts 114 and individually as a backup script 114) that can be executed to back up data associated with the containers 112-1 to 112-M, respectively. Similarly, containers running in the other nodes 110 also include backup scripts. In some embodiments, to back up data associated with the distributed application running on the cluster 100 in response to a user request, the orchestrator 102 causes the backup scripts (e.g., backup scripts 114) within the containers of the cluster 100 to execute. In such cases, each backup script executes to back up data associated with the container in which the backup script runs to the disk 130. The backed up data for all of the containers is shown as backup data 132. In some embodiments, each backup script can perform, or cause to be performed, a known backup technique. In some embodiments, the orchestrator 102 iteratively causes each pod of containers within the cluster 110 to back up associated data to the disk 130. For example, assume one pod of containers executes a relational database management system and another pod of containers executes an implementation of the Lightweight Directory Access Protocol (LDAP). In such a case, each pod can execute a known backup technique for the relational database management system and for the implementation of LDAP, respectively, to back up associated data to the disk 130.

Each of the containers 162-1 to 162-M includes a restoration script 164-1 to 164-M (referred to herein collectively as restoration scripts 164 and individually as a restoration script 164) that can be executed to restore data associated with the containers 162-1 to 162-M, respectively. Similarly, containers running in the other nodes 160 also include restoration scripts. Assuming that the cluster 150 has been created, when the orchestrator 152 determines that backup data 132 has been copied to the disk 180, the orchestrator 152 automatically causes the restoration scripts (e.g., restoration scripts 164) within containers of the cluster 150 to execute. The backup data 132 can be copied to the disk 180 in any technically feasible manner, including manually or automatically. For example, in some embodiments, an enterprise application integration (EAI) route can read the backup data 132 from the disk 130 and write the backup data 132 to the disk 180. Each restoration script executes to restore a portion of the backup data that has been copied to the disk 180 into the container in which the restoration script runs. In some embodiments, each restoration script can perform, or cause to be performed, a known restoration technique. In some embodiments, the orchestrator 152 iteratively causes each pod of containers within the cluster 150 to restore data from the disk 180 into containers of the pod. Returning to the example in which one pod of containers executes a relational database management system and another pod of containers executes an implementation of the LDAP, each pod could execute a known restoration technique for the relational database management system and for the implementation of LDAP, respectively, to restore associated data from the disk 180 into containers of the pod.

Although described herein primarily with respect to migrating data associated with a single cluster to another cluster, in some embodiments, multiple clusters can be migrated using, for example, a script that calls an application programming interface (API) exposed by each of the multiple clusters to back up those clusters.

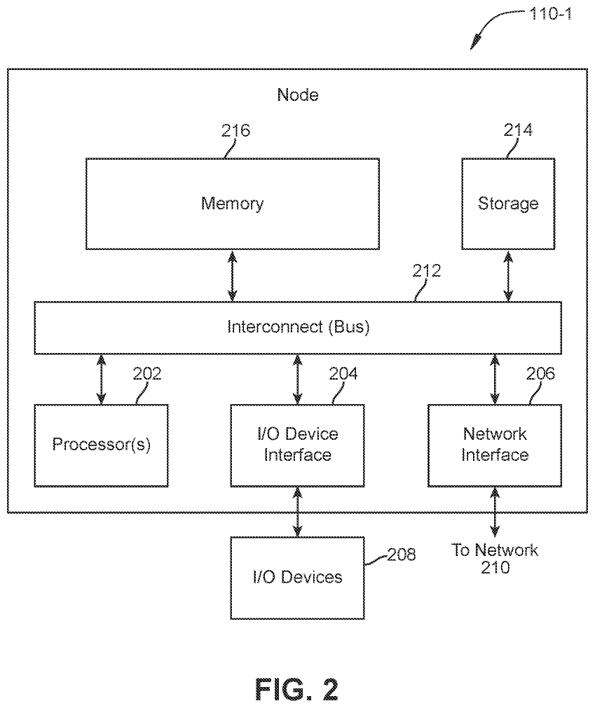

FIG. 2 illustrates in greater detail the node 110-1 of FIG. 1, according to various embodiments. Each of the nodes 110 and 160 can include similar components as the node 110-1 in some embodiments. In some embodiments, the node 110-1 may be a desktop computer, a laptop computer, a server machine, or any other type of computing device configured to receive input, process data, and optionally display images, and is suitable for practicing one or more embodiments of the present invention. It is noted that the node 110-1 described herein is illustrative and that any other technically feasible configurations fall within the scope of the present invention. For example, techniques disclosed herein could be implemented using any number of hardware and/or software components or layers.

In some embodiments, the node 110-1 includes, without limitation, an interconnect (bus) 212 that connects one or more processors 202, an input/output (I/O) device interface 204 coupled to one or more input/output (I/O) devices 208, memory 216, a storage 214 that stores a database 215, and a network interface 206. The processor(s) 202 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, the processor(s) 202 may be any technically feasible hardware unit capable of processing data and/or executing software applications. Further, in the context of this disclosure, the computing elements shown in the node 110-1 may correspond to a physical computing system (e.g., a system in a data center) or may be a virtual computing instance executing within a computing cloud.

In some embodiments, the I/O devices 208 include devices capable of receiving input, such as a keyboard, a mouse, a touchpad, and/or a microphone, as well as devices capable of providing output, such as a display device and/or speaker. Additionally, the I/O devices 208 may include devices capable of both receiving input and providing output, such as a touchscreen, a universal serial bus (USB) port, and so forth. The I/O devices 208 may be configured to receive various types of input from an end-user (e.g., a designer) of the node 110-1, and to also provide various types of output to the end-user of the node 110-1, such as displayed digital images or digital videos or text. In some embodiments, one or more of the I/O devices 208 are configured to couple the node 110-1 to a network 210.

In some embodiments, the network 210 is any technically feasible type of communications network that allows data to be exchanged between the node 110-1 and external entities or devices, such as a web server or another networked computing device. For example, the network 210 could include a wide area network (WAN), a local area network (LAN), a wireless (WiFi) network, and/or the Internet, among others.

In some embodiments, the storage 214 includes non-volatile storage for applications and data, and may include fixed or removable disk drives, flash memory devices, and CD-ROM, DVD-ROM, Blu-Ray, HD-DVD, or other magnetic, optical, or solid-state storage devices. The containers 112 can be stored in the storage 214 and loaded into the memory 216 when executed.

In some embodiments, the memory 216 includes a random access memory (RAM) module, a flash memory unit, or any other type of memory unit or combination thereof. The processor(s) 202, I/O device interface 204, and network interface 206 are configured to read data from and write data to the memory 216. The memory 216 includes various software programs that can be executed by the processor(s) 202 and application data associated with said software programs, including the containers 112.

### Migrating Cluster Data

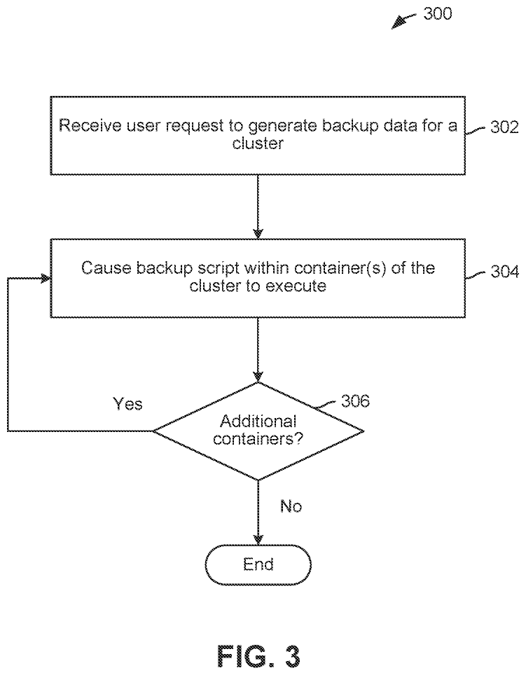

FIG. 3 illustrates a method for backing up cluster data, according to various embodiments. Although the method steps are described in conjunction with the system of FIGS. 1-2, persons of ordinary skill in the art will understand that any system configured to perform the method steps, in any order, is within the scope of the present disclosure.

As shown, a method 300 begins at step 302, where the orchestrator 102 of the cluster 100 receives a user request to generate backup data (e.g., backup data 132) for the cluster 100. In some embodiments, the orchestrator 102 provides a user interface (UI) through which the user can request to generate backup data by, e.g., pressing a button. In some embodiments, in response to such a user request, the orchestrator 102 creates a job based on a time configuration (e.g., a cronjob in Kubernetes®) to back up the data for the cluster 100.

At step 304, the orchestrator 102 causes a backup script within one or more containers of the cluster 100 to execute. In some embodiments, the one or more containers can include containers within a pod of containers. In such cases, each container within the pod of containers can include a backup script that executes to back up data associated with the container to a disk, such as the disk 130. In some embodiments, each backup script can perform, or cause to be performed, a known backup technique.

At step 306, if there are additional containers within the cluster 100 for which backup scripts have not been executed, then the method 300 returns to step 304, where the orchestrator 102 again causes the backup script within one or more other containers, such as the containers of another pod of containers, to execute.

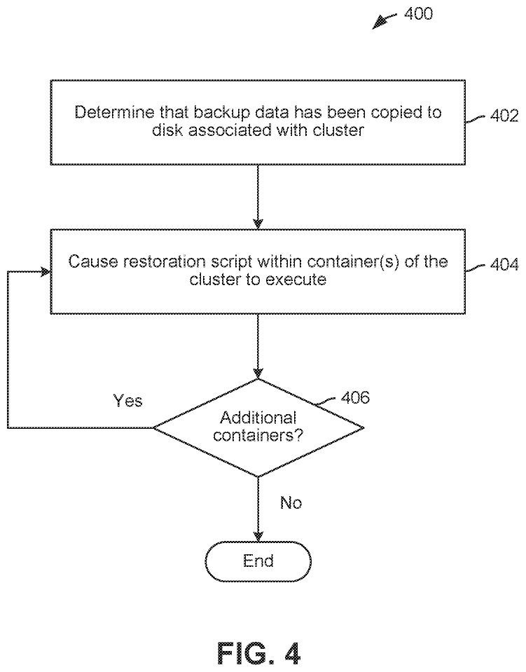

FIG. 4 illustrates a method for restoring backed up data on a cluster, according to various embodiments. Although the method steps are described in conjunction with the system of FIGS. 1-2, persons of ordinary skill in the art will understand that any system configured to perform the method steps, in any order, is within the scope of the present disclosure.

As shown, a method 400 begins at step 402, where the orchestrator 152 of the cluster 150 determines that backup data (e.g., backup data 132) has been copied to the disk 180 associated with the cluster 150. In some embodiments, copying of backup data to the disk 180 triggers the orchestrator 152 to automatically begin a restoration process in which the cluster 150 is restored according to the backup data. As described, in some embodiments, backup data can be copied to the disk 180 in any technically feasible manner, including manually or automatically. For example, in some embodiments, an EAI route can read backup data from the disk 130 of the cluster 100 and write the backup data to the disk 180 of the cluster 150.

At step 404, the orchestrator 152 causes a restoration script in one or more of the containers within the cluster 150 to execute. In some embodiments, the one or more containers can include containers within a pod of containers. In such cases, each container within the pod of containers can include a restoration script that executes to restore appropriate data into the container. In some embodiments, each restoration script could perform, or cause to be performed, a known restoration technique.

At step 406, if there are additional containers within the cluster 150 for which restoration scripts have not been executed, then the method 400 returns to step 404, where the orchestrator 152 again causes the restoration script in one or more other containers, such as the containers of another pod of containers, to execute.

At least one technical advantage of the disclosed techniques relative to the prior art is that an application can be restored on a cluster of nodes having a different configuration than a previous cluster of nodes on which the application was executed. Restoring the application on a cluster of nodes having a different configuration permits the application to be migrated across different computing systems, such as from one cloud computing system to another cloud computer system, from an on-premise data center to a cloud computing system or vice versa, etc. Restoring the application on a cluster of nodes having a different configuration also permits application data to be restored on a different version of an application or a cloned version of an application.

1. In some embodiments, a computer-implemented method for migrating data comprises performing one or more first operations to orchestrate execution of one or more first scripts in one or more first virtual computing instances, wherein the execution of the one or more first scripts causes data associated with the one or more first virtual computing instances to be backed up to at least one first disk, copying the data from the at least one first disk to at least one second disk, and performing one or more second operations to orchestrate execution of one or more second scripts in one or more second virtual computing instances, wherein the execution of the one or more second scripts causes the data to be restored from the at least one second disk to the one or more second virtual computing instances.

2. The computer-implemented method of clause 1, wherein the one or more second operations to orchestrate execution of the one or more second scripts are performed in response to detecting the data has been copied to the at least one second disk.

3. The computer-implemented method of clauses 1 or 2, wherein the one or more first virtual computing instances include a plurality of containers associated with a plurality of pods, and performing the one or more first operations to orchestrate execution of the one or more first scripts comprises iteratively causing one or more containers associated with each pod included in the plurality of pods to execute the one or more first scripts.

4. The computer-implemented method of any of clauses 1-3, wherein the one or more first virtual computing instances include one or more first containers associated with a first pod and one or more second containers associated with a second pod, and the one or more first containers execute a first set of scripts included in the one or more first scripts that is different from a second set of scripts included in the one or more first scripts and executed by the one or more second containers.

5. The computer-implemented method of any of clauses 1-4, further comprising, in response to receiving a user request, creating a job based on a time configuration that causes the one or more first operations to be performed to orchestrate execution of the one or more first scripts.

6. The computer-implemented method of any of clauses 1-5, wherein the data is copied from the at least one first disk to the at least one second disk via an enterprise application integration (EAI) route.

7. The computer-implemented method of any of clauses 1-6, wherein the one or more first virtual computing instances are included in a first cluster of virtual computing instances executing at a first location, and the one or more second virtual computing instances are included in a second cluster of virtual computing instances executing at a second location.

8. The computer-implemented method of any of clauses 1-7, wherein the one or more first operations are performed in response to receiving a call to an application programming interface (API) exposed by the first cluster of virtual computing instances.

9. The computer-implemented method of any of clauses 1-8, wherein the one or more first virtual computing instances execute within at least one of a first cloud computing system or a first data center, and the one or more second virtual computing instances execute within at least one of a second cloud computing system or a second data center.

10. The computer-implemented method of any of clauses 1-9, wherein the one or more first virtual computing instances execute a first version of an application, and the one or more second virtual computing instances execute a second version of the application.

11. In some embodiments, one or more non-transitory computer-readable storage media include instructions that, when executed by one or more processing units, cause the one or more processing units to perform steps for migrating data, the steps comprising performing one or more first operations to orchestrate execution of one or more first scripts in one or more first virtual computing instances, wherein the execution of the one or more first scripts causes data associated with the one or more first virtual computing instances to be backed up to at least one first disk, copying the data from the at least one first disk to at least one second disk, and performing one or more second operations to orchestrate execution of one or more second scripts in one or more second virtual computing instances, wherein the execution of the one or more second scripts causes the data to be restored from the at least one second disk to the one or more second virtual computing instances.

12. The one or more non-transitory computer-readable storage media of clause 11, wherein the one or more second operations to orchestrate execution of the one or more second scripts are performed in response to detecting the data has been copied to the at least one second disk.

13. The one or more non-transitory computer-readable storage media of clauses 11 or 12, wherein the one or more first virtual computing instances include a plurality of containers associated with one or more pods, and performing the one or more first operations to orchestrate execution of the one or more first scripts comprises iteratively causing one or more containers associated with each pod included in the one or more pods to execute the one or more first scripts.

14. The one or more non-transitory computer-readable storage media of any of clauses 11-13, wherein the one or more second virtual computing instances include a plurality of containers associated with one or more pods, and performing the one or more second operations to orchestrate execution of the one or more second scripts comprises iteratively causing one or more containers associated with each pod included in the one or more pods to execute the one or more second scripts.

15. The one or more non-transitory computer-readable storage media of any of clauses 11-14, wherein the one or more first virtual computing instances include one or more first containers associated with a first pod and one or more second containers associated with a second pod, and the one or more first containers execute a first set of scripts included in the one or more first scripts that is different from a second set of scripts included in the one or more first scripts and executed by the one or more second containers.

16. The one or more non-transitory computer-readable storage media of any of clauses 11-15, wherein the instructions, when executed by the one or more processing units, further cause the one or more processing units to perform the step of in response to receiving a user request, creating a job based on a time configuration that causes the one or more first operations to be performed to orchestrate execution of the one or more first scripts.

17. The one or more non-transitory computer-readable storage media of any of clauses 11-16, wherein each virtual computing instance included in the one or more first virtual computing instances comprises a container or a virtual machine (VM).

18. The one or more non-transitory computer-readable storage media of any of clauses 11-17, wherein the one or more first virtual computing instances execute within a first cloud computing system, and the one or more second virtual computing instances execute within a second cloud computing system.

19. The one or more non-transitory computer-readable storage media of any of clauses 11-18, wherein the one or more first virtual computing instances execute a first version of an application, and the one or more second virtual computing instances execute a second version of the application.

20. In some embodiments, a system comprises one or more memories storing instructions, and one or more processors that are coupled to the one or more memories and, when executing the instructions, are configured to perform one or more first operations to orchestrate execution of one or more first scripts in one or more first virtual computing instances, wherein the execution of the one or more first scripts causes data associated with the one or more first virtual computing instances to be backed up to at least one first disk, copy the data from the at least one first disk to at least one second disk, and perform one or more second operations to orchestrate execution of one or more second scripts in one or more second virtual computing instances, wherein the execution of the one or more second scripts causes the data to be restored from the at least one second disk to the one or more second virtual computing instances.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for migrating data, the method comprising:
performing one or more first operations to orchestrate execution of one or more first scripts in one or more first virtual computing instances, wherein the execution of the one or more first scripts causes data associated with the one or more first virtual computing instances to be backed up to at least one first disk;
copying the data from the at least one first disk to at least one second disk; and
performing one or more second operations to orchestrate execution of one or more second scripts in one or more second virtual computing instances, wherein the execution of the one or more second scripts causes the data to be restored from the at least one second disk to the one or more second virtual computing instances.

2. The computer-implemented method of claim 1, wherein the one or more second operations to orchestrate execution of the one or more second scripts are performed in response to detecting the data has been copied to the at least one second disk.

3. The computer-implemented method of claim 1, wherein the one or more first virtual computing instances include a plurality of containers associated with a plurality of pods, and performing the one or more first operations to orchestrate execution of the one or more first scripts comprises iteratively causing one or more containers associated with each pod included in the plurality of pods to execute the one or more first scripts.

4. The computer-implemented method of claim 1, wherein the one or more first virtual computing instances include one or more first containers associated with a first pod and one or more second containers associated with a second pod, and the one or more first containers execute a first set of scripts included in the one or more first scripts that is different from a second set of scripts included in the one or more first scripts and executed by the one or more second containers.

5. The computer-implemented method of claim 1, further comprising, in response to receiving a user request, creating a job based on a time configuration that causes the one or more first operations to be performed to orchestrate execution of the one or more first scripts.

6. The computer-implemented method of claim 1, wherein the data is copied from the at least one first disk to the at least one second disk via an enterprise application integration (EAI) route.

7. The computer-implemented method of claim 1, wherein the one or more first virtual computing instances are included in a first cluster of virtual computing instances executing at a first location, and the one or more second virtual computing instances are included in a second cluster of virtual computing instances executing at a second location.

8. The computer-implemented method of claim 7, wherein the one or more first operations are performed in response to receiving a call to an application programming interface (API) exposed by the first cluster of virtual computing instances.

9. The computer-implemented method of claim 1, wherein the one or more first virtual computing instances execute within at least one of a first cloud computing system or a first data center, and the one or more second virtual computing instances execute within at least one of a second cloud computing system or a second data center.

10. The computer-implemented method of claim 1, wherein the one or more first virtual computing instances execute a first version of an application, and the one or more second virtual computing instances execute a second version of the application.

11. One or more non-transitory computer-readable storage media including instructions that, when executed by one or more processing units, cause the one or more processing units to perform steps for migrating data, the steps comprising:
performing one or more first operations to orchestrate execution of one or more first scripts in one or more first virtual computing instances, wherein the execution of the one or more first scripts causes data associated with the one or more first virtual computing instances to be backed up to at least one first disk;
copying the data from the at least one first disk to at least one second disk; and
performing one or more second operations to orchestrate execution of one or more second scripts in one or more second virtual computing instances, wherein the execution of the one or more second scripts causes the data to be restored from the at least one second disk to the one or more second virtual computing instances.

12. The one or more non-transitory computer-readable storage media of claim 11, wherein the one or more second operations to orchestrate execution of the one or more second scripts are performed in response to detecting the data has been copied to the at least one second disk.

13. The one or more non-transitory computer-readable storage media of claim 11, wherein the one or more first virtual computing instances include a plurality of containers associated with one or more pods, and performing the one or more first operations to orchestrate execution of the one or more first scripts comprises iteratively causing one or more containers associated with each pod included in the one or more pods to execute the one or more first scripts.

14. The one or more non-transitory computer-readable storage media of claim 11, wherein the one or more second virtual computing instances include a plurality of containers associated with one or more pods, and performing the one or more second operations to orchestrate execution of the one or more second scripts comprises iteratively causing one or more containers associated with each pod included in the one or more pods to execute the one or more second scripts.

15. The one or more non-transitory computer-readable storage media of claim 11, wherein the one or more first virtual computing instances include one or more first containers associated with a first pod and one or more second containers associated with a second pod, and the one or more first containers execute a first set of scripts included in the one or more first scripts that is different from a second set of scripts included in the one or more first scripts and executed by the one or more second containers.

16. The one or more non-transitory computer-readable storage media of claim 11, wherein the instructions, when executed by the one or more processing units, further cause the one or more processing units to perform the step of in response to receiving a user request, creating a job based on a time configuration that causes the one or more first operations to be performed to orchestrate execution of the one or more first scripts.

17. The one or more non-transitory computer-readable storage media of claim 11, wherein each virtual computing instance included in the one or more first virtual computing instances comprises a container or a virtual machine (VM).

18. The one or more non-transitory computer-readable storage media of claim 11, wherein the one or more first virtual computing instances execute within a first cloud computing system, and the one or more second virtual computing instances execute within a second cloud computing system.

19. The one or more non-transitory computer-readable storage media of claim 11, wherein the one or more first virtual computing instances execute a first version of an application, and the one or more second virtual computing instances execute a second version of the application.

20. A system, comprising:
one or more memories storing instructions; and
one or more processors that are coupled to the one or more memories and, when executing the instructions, are configured to:
perform one or more first operations to orchestrate execution of one or more first scripts in one or more first virtual computing instances, wherein the execution of the one or more first scripts causes data associated with the one or more first virtual computing instances to be backed up to at least one first disk,
copy the data from the at least one first disk to at least one second disk, and
perform one or more second operations to orchestrate execution of one or more second scripts in one or more second virtual computing instances, wherein the execution of the one or more second scripts causes the data to be restored from the at least one second disk to the one or more second virtual computing instances.
